(19) United States
(12) Patent Application Publication
(10) Pub. No.: US 2021/0111397 A1
(43) Pub. Date: Apr. 15, 2021

(54) SECONDARY LITHIUM BATTERY AND MANUFACTURING METHOD

(71) Applicant: VARTA Microbattery GmbH, Ellwangen Jagst (DE)

(72) Inventors: Claus-Christian Fischer, Ellwangen (DE); Goran Kilibarda, Schwabisch Gmund (DE); Bernd Kreidler, Ellwangen (DE); Sebastian Schebesta, Ellwangen (DE)

(21) Appl. No.: 17/064,743

(22) Filed: Oct. 7, 2020

(30) Foreign Application Priority Data
Oct. 10, 2019 (EP) 19202405.7

(51) Int. Cl. H01M 4/36; H01M 4/66; H01M 4/04; H01M 2/26; H01M 2/04; H01M 10/0525; H01M 10/0587

(52) U.S. Cl. CPC H01M 4/366; H01M 4/662; H01M 4/0428; H01M 2004/028; H01M 2/0482; H01M 10/0525; H01M 10/0587; H01M 2/263

(57) ABSTRACT

A secondary lithium battery includes (a) a housing enclosing an interior space, and (b) a composite body arranged in the interior space and including at least one positive electrode, at least one negative electrode and at least one separator, wherein (c) the housing includes a metal housing part having an inner side pointing into the interior space and an outer side pointing away from the interior space, and (d) the metal housing part includes: a first layer consisting of aluminium or an aluminium alloy that forms the inner side of the metal housing part, and in direct contact with the first layer, a second layer consisting of nickel or a nickel alloy that forms the outer side of the metal housing part.

### TECHNICAL FIELD

This disclosure relates to a secondary lithium battery and a method of manufacturing a secondary lithium battery.

### BACKGROUND

A “battery” was originally understood to mean a plurality of electrically interconnected electrochemical cells capable of storing electrical energy and arranged in a common housing. Nowadays however, individual electrochemical cells (individual cells) in a housing are also often referred to as a battery. The same definition is also applied here. The term “battery” thus also comprises an individual electrochemical cell, capable of storing electrical energy, in a housing.

Electrochemical cells comprise a positive electrode, a negative electrode and a separator that separates the positive and the negative electrode from one another. The electrodes and the separator are usually impregnated with an electrolyte. A housing closed off in a liquidtight manner generally encloses the electrodes, the separator and the electrolyte.

An electrochemical energy-yielding reaction takes place in electrochemical cells capable of storing electrical energy, which reaction consists of two electrically interlinked but spatially separate partial reactions. One partial reaction that takes place at a comparatively lower redox potential occurs at the negative electrode, and one partial reaction that takes place at a comparatively higher redox potential occurs at the positive electrode. During discharge, electrons are released at the negative electrode through an oxidation process, resulting in a flow of electrons across an external consumer to the positive electrode, from which a corresponding amount of electrons is absorbed. A reduction process thus takes place at the positive electrode. At the same time, there is a flow of ions, corresponding to the electrode reaction, within the cell for charge balancing purposes. This flow of ions is ensured by an ion-conducting electrolyte.

In secondary (rechargeable) cells, the discharge reaction is reversible, and there is thus the option of reversing the conversion of chemical energy into electrical energy that took place during the discharge. If the terms “anode” and “cathode” are used in connection with secondary cells, the electrodes are generally named according to their discharge function. The negative electrode in such cells is thus the anode, and the positive electrode is the cathode.

One known example of a rechargeable electrochemical cell is the secondary lithium-ion cell. This comprises electrodes that are able to reversibly absorb lithium ions and release them again, and an electrolyte that contains lithium ions.

Lithium-ion cells generally contain their electrodes and separators in the form of a composite body. Such a composite body may be a cell stack consisting of a plurality of individual cells. The composite body is however very often also an individual cell in wound form (wound composite body).

Positive and negative electrodes and separators usually lie flat on top of one another in composite bodies. The electrodes and separators are usually, for example, connected to one another through lamination or through adhesive bonding. Composite bodies, regardless of whether or not they are wound, usually comprise the sequence positive electrode/separator/negative electrode. Composite bodies are often manufactured as what are known as dual cells with the possible sequences: negative electrode/separator/positive electrode/separator/negative electrode or positive electrode/separator/negative electrode/separator/positive electrode.

The electrodes of lithium-ion cells usually each comprise a metal current collector and electrochemically active components (often also referred to as active materials) and electrochemically inactive components.

The current collectors make electrical contact with the electrochemically active components over as large an area as possible. They usually consist of strip-shaped, flat metal substrates, for example, consisting of metal foils or a foamed metal or else a metallized nonwoven.

All materials that are able to absorb lithium ions and release them again come into consideration as active materials for secondary lithium-ion systems. Carbon-based materials such as graphite carbon or non-graphite carbon materials capable of intercalating lithium are known in this respect for the negative electrode of secondary lithium-ion systems. Metal and semi-metal materials able to be alloyed with lithium furthermore may also be used. The elements tin, antimony and silicon are thus, for example, capable of forming intermetallic phases with lithium. The carbon-based active materials may, in particular, also be combined with the metal and/or semi-metal materials.

Lithium metal oxide compounds and lithium metal phosphate compounds such as LiCoO₂ and LiFePO₄ come into consideration for the positive electrode of secondary lithium-ion systems, for example. Lithium nickel manganese cobalt oxide (NMC) having the molecular formula LiNiₓMn_{y}Co_{z}O₂ (wherein x+y+z is typically 1), lithium manganese oxide (LMO) having the molecular formula LiMn₂O₄, or lithium nickel cobalt aluminium oxide (NCA) having the molecular formula LiNiₓCo_{y}Al_{z}O₂ (wherein x+y+z is typically 1) are in particular also well-suited. Mixtures of the materials may also be used.

Electrode binders and conductors may be mentioned first and foremost as electrochemically inactive components. Electrode binders ensure mechanical stability of the electrodes and create contact between the particles consisting of electrochemically active material and contact between the particles and the current collector. Conductors such as carbon black increase the electrical conductivity of the electrodes.

Porous plastic films, for example, consisting of a polyolefin or of a polyetherketone in particular come into consideration as separators for lithium-ion cells. Nonwovens and fabrics consisting of these materials may also be used.

Lithium-ion cells may, for example, contain a mixture of organic carbonates in which a lithium salt such as lithium tetrafluoroborate is dissolved as ion-conducting electrolyte. The electrodes and separators of the lithium-ion cells are preferably impregnated with the electrolyte.

Button cells having lithium ion-based winding composite bodies manufactured by winding strip-shaped electrodes and at least one strip-shaped separator in a spiral are described, for example, in WO 2010/146154 A2 and in WO 2010/089152 A1. The described composite bodies are arranged in metal housings that usually consist of nickel-plated steel or sheet metal.

The metal housing materials are well-suited, in particular, for the manufacture of button cell housings. Button cell housings generally consist of cup-shaped housing parts that are manufactured in deep-drawing processes with thicknesses of 100 to 300 μm. This is possible without problems with nickel-plated steel or sheet metal. One problem is, however, the fact that cell housings consisting of such materials are susceptible to corrosion when they are in contact with the electrodes and the electrolyte of a lithium-ion cell.

Aluminium housings are therefore often used for lithium-ion cells in the automotive sector, which aluminium housings have sufficient electrochemical stability on account of their passivation properties. We attempted, in a manner similar thereto, to manufacture small-format button cell housings by shaping very thin aluminium sheets, but this proved to be highly challenging in terms of process engineering due to the lower ductility of aluminium compared to steel and sheet metal. In addition, the housing parts obtained in the subsequent assembly processes were very difficult to handle due to their mechanical sensitivity (aluminium is a very soft metal).

In a further approach, steel sheet metal coated on one side with aluminium was treated as starting material for manufacturing button cell housings. This yielded better results than in aluminium sheets. However, the aluminium coating led to high abrasion on the deep-drawing tools that were used that acted on the tools and caused problems.

### SUMMARY

We provide a secondary lithium battery including (a) a housing enclosing an interior space, and (b) a composite body arranged in the interior space and including at least one positive electrode, at least one negative electrode and at least one separator, wherein (c) the housing includes a metal housing part having an inner side pointing into the interior space and an outer side pointing away from the interior space, and (d) the metal housing part includes a first layer consisting of aluminium or an aluminium alloy that forms the inner side of the metal housing part, and in direct contact with the first layer, a second layer consisting of nickel or a nickel alloy that forms the outer side of the metal housing part.

We also provide a method of manufacturing the battery including (a) a housing enclosing an interior space, and (b) a composite body arranged in the interior space and including at least one positive electrode, at least one negative electrode and at least one separator, wherein (c) the housing includes a metal housing part having an inner side pointing into the interior space and an outer side pointing away from the interior space, and (d) the metal housing part includes a first layer consisting of aluminium or an aluminium alloy that forms the inner side of the metal housing part, and in direct contact with the first layer, a second layer consisting of nickel or a nickel alloy that forms the outer side of the metal housing part, the method including (a) providing a foil or a metal sheet consisting of aluminium or of an aluminium alloy, (b) applying a layer consisting of nickel or of a nickel alloy to one side of the foil or of the metal sheet, (c) shaping the foil or metal sheet resulting from step (b) using a deep-drawing tool to form a metal housing part the inner side of which is formed by the foil or the metal sheet consisting of the aluminium or of the aluminium alloy and the outer side of which is formed by the layer consisting of the nickel or of the nickel alloy, and assembling the lithium battery using the housing part formed in step (c).

### BRIEF DESCRIPTION OF THE DRAWING

The drawing shows an example of a lithium battery in a cross-sectional view.

### DETAILED DESCRIPTION

Our lithium battery is distinguished by the following features:
(a) a housing enclosing an interior,
(b) a composite body arranged in the interior and comprising at least one positive electrode and at least one negative electrode and at least one separator, wherein
(c) the housing comprises a metal housing part having an inner side pointing into the interior and an outer side pointing away from the interior, and
(d) the metal housing part comprises:
   a first layer consisting of aluminium or of an aluminium alloy that preferably forms the inner side of the metal housing part, and
   in direct contact with the first layer a second layer consisting of nickel or of a nickel alloy that forms the outer side of the metal housing part.

Preferably, the metal housing part comprises only the first layer and the second layer and no more other layers. More preferably, the metal housing part consists of the first layer and of the second layer.

The battery is thus distinguished by a housing part that has been manufactured completely without stainless steel and steel sheets. Instead, it preferably consists solely of the aluminium or the aluminium alloy and the nickel or the nickel alloy.

We surprisingly found that the second layer consisting of the nickel or the nickel alloy gives the metal housing part a mechanical stability that was not expected as such a priori. Even nickel layers of less than 1 μm in thickness ensured a significant increase in its rigidity, meaning that the rejection rate in subsequent assembly processes was able to be considerably reduced. Fewer problems in the shaping process in particular in connection with the mentioned abrasion, furthermore also occurred.

The thickness of the nickel layer is able to be set in a targeted manner, which is described in more detail further below.

The nickel or the nickel alloy may in principle also be replaced with a metal material from the group containing gold, silver, chromium, gold alloy, silver alloy and chromium alloy. The nickel and the nickel alloy are, however, preferred.

The lithium battery is preferably distinguished by at least one of the additional features (a) and (b) directly below:
(a) The first layer consisting of the aluminium or of the aluminium alloy has a thickness of 10 μm to 1500 μm, preferably 50 μm to 1000 μm in particular 50 μm to 500 μm, particularly preferably 50 μm to 150 μm.
(b) The second layer consisting of the nickel or of the nickel alloy has a thickness of 0.1 μm to 100 μm, preferably 0.1 μm to 50 μm in particular 1 μm to 10 μm, particularly preferably 3 μm to 10 μm.

Features (a) and (b) directly above are particularly preferably implemented in combination with one another.

The composite body of the lithium battery does not have to differ from known composite bodies and mentioned at the outset. Like these, it comprises the electrodes and the at least one separator or consists of the electrodes and the separator. It particularly preferably has at least one of the features (a) to (c) directly below:
(a) The composite body comprises the electrodes in stacked form or in wound form.
(b) The electrodes are able to reversibly store and release lithium ions.
(c) The electrodes each comprise a current collector partly covered with an active material. Features (a) to (c) directly above are particularly preferably implemented in combination with one another.

In a winding composite body, the composite body may have a cylindrical or hollow-cylindrical geometry, for instance like the winding composite bodies illustrated in FIGS. 3a and 3b of WO 2010/146154 A2. The winding is then manufactured from strip-shaped electrodes and at least one strip-shaped separator.

The winding composite body is preferably impregnated with an electrolyte that is normal for lithium-ion cells.

The current collectors of the electrodes are preferably a film, a foil, a net, a grating, a foam, a nonwoven or another textile structure consisting of a metal or a metal alloy. On the anode side, the current collectors preferably consist of copper or a copper alloy, and on the cathode side they consist of aluminium or an aluminium alloy.

The lithium battery is particularly preferably distinguished by the feature (d) directly below:
(d) The positive electrode is electrically connected to the metal housing part.

The current collectors preferably have at least one section not covered with an active material. Preferably, this section may serve directly as current conductor that electrically connects the positive electrode to the metal housing part. Alternatively, the current conductor may also be a separate conductor that is welded, for example, to that section of the current collector not covered with the active material. In the latter configuration, the current conductor is preferably a metal foil in particular an aluminium foil.

The current conductor is preferably welded to the inner side of the metal housing part that is to say it is preferably welded to the first layer consisting of the aluminium or of the aluminium alloy. This is particularly advantageous when the current conductor itself consists of the same material as the first layer. As is known, aluminium is able to be welded particularly well to aluminium, for example.

The lithium battery may be both a single electrochemical cell arranged in a housing and a multiplicity of electrically interconnected cells in a common housing. There are five particularly preferred configurations of the lithium battery.

Configuration 1

In this example, the lithium battery is distinguished by at least one of the features (a) to (d) directly below:
(a) The housing comprises the metal housing part as first housing part and a further metal housing part as second housing part.
(b) The first and the second housing part are both designed in a cup shape and each have a circular or oval base and an annular side wall.
(c) The first and the second housing part are electrically isolated from one another by an annular seal having electrically insulating properties.
(d) The first housing part is electrically connected to the positive electrode and the second housing part is electrically connected to the negative electrode.

Features (a) to (d) directly above are particularly preferably implemented in combination with one another.

In this example, the lithium battery is preferably a button cell, preferably with a diameter of 5 mm to 25 mm. The height of the lithium battery does not exceed its diameter in the example of a button cell form.

In one example, both in the first housing part and in the second housing part, it is preferred for the base and the annular side wall to be connected to one another by a transition region. The transition regions preferably comprise the regions of the housing parts that are outside the plane of the respective base but are not yet part of the associated side wall. The transition regions may have a rounded design, for example, a collar-shaped design, or else be in the shape of a sharp edge.

The transition regions delimit the side walls with respect to the bases. Towards the other side, the side walls are preferably delimited in both examples by a circumferential free edge that defines a circular or oval opening.

Preferably, the annular side walls of the housing parts have a cylindrical geometry. The side walls may particularly preferably each enclose an angle of 90° with the bases.

In Configuration 1, the first housing part preferably has an overall thickness (added thicknesses of the first and the second layer) of 50 μm to 200 μm, particularly preferably 50 μm to 150 μm. In Configuration 1, the second layer consisting of the nickel or of the nickel alloy preferably has a thickness of 1 μm to 10 μm, particularly preferably 3 μm to 10 μm.

The thickness of the second housing part likewise preferably varies at 50 μm to 200 μm. The second housing part, as in conventional button cells, may consist, for example, of nickel-plated steel sheet metal.

When the housing is assembled, the first housing part is preferably inserted into the second housing part with the free edge of its side wall at the front such that the annular side wall of the first housing part and the annular side wall of the second housing part overlap at least in regions and form a circumferential double-wall casing, and the bases of the first and the second housing part are oriented parallel to one another. Alternatively, the second housing part may also be inserted into the first housing part with the free edge of its side wall at the front such that the annular side wall of the first housing part and the annular side wall of the second housing part overlap at least in regions and form a circumferential double-wall casing, and the bases of the first and the second housing part are oriented parallel to one another.

The dimensions of the first and of the second housing part have to be adapted to one another accordingly. The housing part that is intended to be inserted into the other one normally has an annular side wall having a smaller diameter than the side wall of the other housing part. In configuration 1 of the lithium battery, the first housing part is preferably the one with the annular side wall that has the smaller diameter.

The annular seal is usually also pushed onto the side wall having the smaller diameter before the housing parts are joined together. The composite body is furthermore usually positioned in the housing part having the smaller casing before the housing parts are joined together.

The annular seal preferably consists of a plastic with electrically insulating properties, for example, polypropylene (PP) or a polyetheretherketone (PEEK). It first has the task of electrically insulating the housing parts from one another. The seal is furthermore intended to ensure liquidtight closure of the housing.

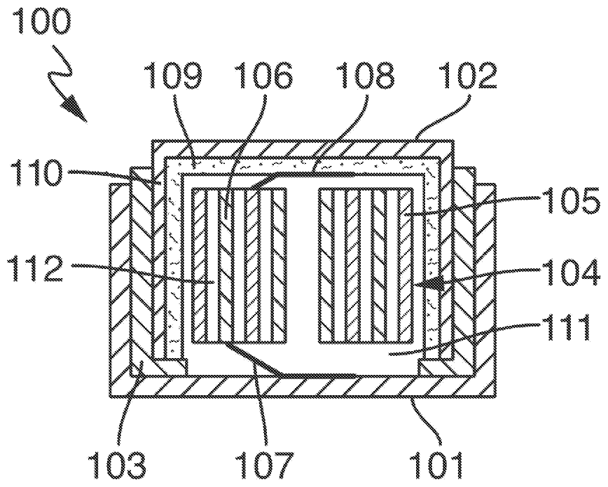

In some examples, to close off the housing, the free circumferential edge of the larger housing part may be bent inwardly (closure by crimping). In principle, however, crimp-free closure is also possible such as that illustrated for instance in FIG. 1 of WO 2010/146154 A2.

The electrical connections between the first housing part and the positive electrode and the second housing part and the negative electrode may be formed before or after joining together. In the latter example, resistance welding or laser welding may, for example, be performed through the wall of the housing.

As explained above, the positive electrode is preferably welded to the inner side of the first housing part via a current conductor. The negative electrode is preferably welded to an inner side, facing into the interior, of the second housing part.

Configuration 2

In this example, the lithium battery is distinguished by at least one of the features (a) to (d) directly below:
(a) The housing comprises the metal housing part as first housing part and a further metal housing part as second housing part.
(b) The first housing part has a cup-shaped design and has a circular base and an annular side wall, whereas the second housing part is designed as a circular disc.
(c) The first and the second housing part are electrically isolated from one another by an annular seal having electrically insulating properties.
(d) The first housing part is electrically connected to the positive electrode and the second housing part is electrically connected to the negative electrode.

Features (a) to (d) directly above are particularly preferably implemented in combination with one another.

In this example, the lithium battery is preferably a cylindrical round cell, preferably having a diameter of 5 mm to 25 mm. The height of the lithium battery exceeds its diameter, preferably by a factor of 1.1 to 10 in particular by a factor of 1.5 to 5.

In one example, the base and the annular side wall of the first housing part are connected to one another by a transition region. This preferably comprises the region of the first housing part that lies outside the plane of the base but is not yet part of the side wall. The transition region may have a rounded design, for example, a collar-shaped design, or else be in the shape of a sharp edge.

The transition region delimits the side wall of the first housing part towards its base. Towards the other side, the side wall is preferably delimited by a circumferential free edge that defines a circular opening.

Preferably, the annular side wall of the first housing part has a cylindrical geometry. The side wall particularly preferably encloses an angle of 90° with the base.

In Configuration 2, the first housing part preferably has an overall thickness (added thicknesses of the first and the second layer) of 50 μm to 200 μm, particularly preferably 50 μm to 150 μm. In Configuration 2, the second layer consisting of the nickel or of the nickel alloy preferably has a thickness of 1 μm to 10 μm, particularly preferably 3 μm to 10 μm.

The thickness of the second housing part preferably varies from 50 μm to 300 μm. The second housing part may consist, for example, of nickel-plated steel sheet metal.

When the housing is assembled, the circular opening, defined by the free edge of the side wall of the first housing part, is closed off by the second housing part. The annular seal is preferably applied beforehand to the periphery of the disc-shaped second housing part. The second housing part and the seal may optionally be treated as a preassembled component. The housing may be closed off, for example, through a crimping process.

The electrical connections between the first housing part and the positive electrode and the second housing part and the negative electrode may be formed in the same way as in the procedures described with respect to variant 1.

Configuration 3

In this example, the lithium battery is distinguished by at least one of the features (a) to (d) directly below:
(a) The housing comprises the metal housing part as first housing part and a further metal housing part as second housing part.
(b) The first housing part has a cup-shaped design and has a circular base and an annular side wall, whereas the second housing part is designed as a circular disc.
(c) The first and the second housing part are electrically isolated from one another by an annular seal having electrically insulating properties.
(d) The first housing part is electrically connected to the negative electrode and the second housing part is electrically connected to the positive electrode.

Features (a) to (d) directly above are particularly preferably implemented in combination with one another.

The lithium battery according to this example differs from the lithium battery according to Configuration 2 only in that the housing polarity is reversed.

Configuration 4

In this example, the lithium battery is distinguished by at least one of the features (a) to (c) directly below:
(a) The housing comprises the metal housing part as first housing part and a further non-metal housing part as second housing part.
(b) The metal housing part is designed as a prismatic container that has a polygonal base with n sides and n rectangular side walls that enclose a right angle with the base, wherein n is an integer from 4 to 8.
(c) The second housing part serves as cover for the first housing part and closes off an opening defined by the n rectangular side walls.

Features (a) to (c) directly above are particularly preferably implemented in combination with one another.

In this example, the lithium battery is preferably a prismatic miniature cell, as described in WO 2019/096856 A1. In this example, the first housing part may be connected to the positive electrode whereas the negative electrode is connected to an electrical conductor that is routed out of the housing via the second housing part. Alternatively, both the positive and the negative electrode may be connected to electrical conductors that are routed out of the housing via the second housing part.

The second housing part preferably consists of an electrically insulating plastic in particular a thermoplastic elastomer.

The miniature cell preferably has a cuboidal design and preferably has a width of 20 mm to 100 mm, a length of 10 mm to 100 mm and a height of 1.5 mm to 5 mm. Its nominal capacity in accordance with IEC/EN 61960 is preferably 100 mAh to 1000 mAh.

In Configuration 4, the first housing part preferably has an overall thickness (added thicknesses of the first and the second layer) of 50 μm to 200 μm, particularly preferably 50 μm to 150 μm. In Configuration 4, the second layer consisting of the nickel or of the nickel alloy preferably has a thickness of 1 μm to 10 μm, particularly preferably 3 μm to 10 μm.

Configuration 5

In this example, the lithium battery is distinguished by at least one of the features (a) to (c) directly below:
(a) The housing comprises the metal housing part as first housing part and a further metal housing part as second housing part.
(b) The metal housing part is designed as a prismatic container that has a polygonal base with n sides and n rectangular side walls that enclose a right angle with the base, wherein n is an integer of 4 to 8.
(c) The second housing part serves as cover for the first housing part and closes off an opening defined by the n rectangular side walls.

Features (a) to (c) directly above are particularly preferably implemented in combination with one another.

In this example, the lithium battery is preferably a battery for a motor vehicle. In this example, the first housing part may be connected to the positive electrode whereas the negative electrode is connected to an electrical conductor that is routed out of the housing via a pole feedthrough in the second housing part or in the first housing part. Alternatively, both the positive and the negative electrode may be connected to electrical conductors that are routed out of the housing via pole feedthroughs in the first and/or in the second housing part.

The second housing part preferably has the same multilayer structure, containing the layer consisting of aluminium or of an aluminium alloy and the layer consisting of nickel or of a nickel alloy, as the first housing part.

Particularly preferably, the lithium battery is distinguished by at least one of the features (a) to (d) directly below:
(a) The first layer also comprises lithium in addition to the aluminium or the aluminium alloy.
(b) The first layer is coated with a layer consisting of lithium.
(c) The first layer is lithium doped.
(d) The aluminium in the first layer is alloyed with lithium.

Features (a) and (b), (a) and (c) and (a) and (d) directly above are particularly preferably implemented in combination with one another.

In secondary lithium-ion cells, even in the first charging and discharging cycle (known as the forming), a cover layer is formed on the surface of the electrochemically active materials in the anode. This cover layer is called “solid electrolyte interphase” (SEI) and generally primarily consists of electrolyte decomposition products and a certain amount of lithium. This lithium is fixedly bonded in the SEI. This decreases the amount of lithium that is still available for absorption and release procedures or for charging and discharging reactions, which may lead to decreases in capacity and power. The loss of lithium during forming, but also in following cycles, should therefore ideally be compensated. This compensation is brought about by way of the lithium contained in the first layer. The lithium may very easily be applied in or on the layer, specifically, for example, by sputtering or by way of a CVD process. Once it has been incorporated into the housing, it may exhibit a deposition effect and compensate losses during charging and discharging.

The proportion by weight of lithium contained in the first layer is preferably <1% by weight.

In examples when the first layer is coated completely with the layer consisting of lithium, the layer of lithium forms the inner side of the metal housing part in particular of the first housing part. In all other examples it is preferred that the first layer consisting of aluminium or of an aluminium alloy forms the inner side of the metal housing part in particular of the first housing part.

Preferably, the metal housing part in particular the first housing part, comprises only the first layer and the second layer and the layer consisting of lithium and no more other layers. More preferably, the metal housing part consists of the first layer and of the second layer and of the layer consisting of lithium.

The first layer preferably consists of aluminium having a purity of more than 95% by weight in particular of more than 99% by weight. If the first layer is an aluminium alloy, the first layer may have alloy partners such as, for example, Fe, Mn, Mg, Si and/or Cu in particular at a proportion of 0.1 to 5% by weight.

The second layer preferably consists of nickel having a purity of more than 95% by weight in particular of more than 99% by weight. If the second layer is a nickel alloy, the second layer may have alloy partners such as, for example, Al, Ti, Fe, Mo, Cr, and/or Co in particular at a proportion of up to 20% by weight.

The method is used to manufacture a secondary lithium battery having the features described above, and is always distinguished by the steps (a) to (d) directly below:
(a) Providing a foil or a metal sheet consisting of aluminium or of an aluminium alloy.
(b) Applying a layer consisting of nickel or of a nickel alloy to one side of the foil or of the metal sheet.
(c) Shaping the foil or metal sheet resulting from step (b) using a deep-drawing tool to form a metal housing part the inner side of which is formed by the foil or the metal sheet consisting of the aluminium or of the aluminium alloy and the outer side of which is formed by the layer consisting of the nickel or of the nickel alloy.
(d) Assembling the lithium battery using the housing part formed in step (c).

The layer consisting of the nickel or of the nickel alloy may be applied in various ways.

In a first preferred example, the method to this end comprises the following additional step:
(a) The layer consisting of the nickel or of the nickel alloy is applied to the foil or to the metal sheet consisting of the aluminium or of the aluminium alloy through a CVD or a PVD method.

In a second preferred example, the method to this end comprises the following additional step:
(a) A foil consisting of nickel or of the nickel alloy is roll-coated onto the foil or onto the metal sheet consisting of the aluminium or of the aluminium alloy to form the layer consisting of the nickel or of the nickel alloy.

According to the first preferred example, layer thicknesses of up to 10 μm may be set in a variable manner. For higher layer thicknesses, the second preferred example is preferably used.

Preferably after the shaping in step (c) it is possible to apply lithium to the first layer, as explained above.

Further features, details and preferences will become apparent from the claims and the abstract, the wording in both of which is given with reference to the contents of the description, of the following description of one preferred example and with reference to the drawing. In this configuration, schematically and not to scale.

The secondary lithium battery 100 illustrated in the Drawing has a housing formed of the first housing part 102 and the second housing part 101. Both housing parts 102 and 101 consist of metal materials. The housing part 101 consists of stainless steel. The housing part 102 consists of a layer 109 consisting of aluminium and a layer 110 consisting of nickel. The layer 109 has a thickness in the range from 120 to 150 μm. The layer 110 has a thickness of roughly 5 μm. The housing parts 101 and 102 are both designed in a cup shape and each comprise a circular base and an annular side wall.

The seal 103 that seals off the housing is arranged between the housing parts 102 and 101. The housing encloses an interior 111 in which the composite body 104 is arranged. The composite body is manufactured from the positive electrode 105, the negative electrode 106 and the separator 112 and is present in the form of a winding. The end faces of the winding point in the direction of the bases of the housing parts 101 and 102.

The electrodes 105 and 106 each comprise a current collector predominantly covered with an active material and is therefore also not visible over large parts, apart from the partial regions 107 and 108 not covered with active material. These partial regions 107 and 108 in this example operate as current conductors. The current conductor 108 connects the positive electrode 105 to the cup-shaped first housing part 102. The negative electrode 106 is connected to the second housing part 101 via the current conductor 107. The collector for the negative electrode 106 and thus the current conductor 107 is a copper foil. The collector for the positive electrode 105 and thus the current conductor 108 is an aluminium foil.

The current conductor 108 is connected to the inner side, formed from the layer 109, of the cup-shaped housing part 102 through welding. The current conductor 107 is connected to the inner side of the base of the housing part 101, likewise through welding.

1. A secondary lithium battery comprising:
(a) a housing enclosing an interior space, and
(b) a composite body arranged in the interior space and comprising at least one positive electrode, at least one negative electrode and at least one separator, wherein
(c) the housing comprises a metal housing part having an inner side pointing into the interior space and an outer side pointing away from the interior space, and
(d) the metal housing part comprises:
a first layer consisting of aluminium or an aluminium alloy that forms the inner side of the metal housing part, and
in direct contact with the first layer, a second layer consisting of nickel or a nickel alloy that forms the outer side of the metal housing part.

2. The lithium battery according to claim 1, wherein
the first layer consists of the aluminium or the aluminium alloy having a thickness of 10 μm to 1500 μm, and
the second layer consists of the nickel or the nickel alloy having a thickness of 0.1 μm to 100 μm.

3. The battery according to claim, wherein
the composite body comprises the electrodes in stacked form or in wound form,
the electrodes are able to reversibly store and release lithium ions,
the electrodes each comprise a current collector partly covered with an active material, and
the positive electrode is electrically connected to the metal housing part.

4. The battery according to claim 1, wherein
the housing comprises the metal housing part as first housing part and a further metal housing part as second housing part,
the first and the second housing part are both in a cup shape and each have a circular or oval base and an annular side wall,
the first and the second housing part are electrically isolated from one another by an annular seal having electrically insulating properties, and
the first housing part is electrically connected to the positive electrode and the second housing part is electrically connected to the negative electrode.

5. The battery according to claim 1, wherein
the housing comprises the metal housing part as first housing part and a further metal housing part as second housing part,
the first housing part has a cup-shaped design and a circular base and an annular side wall, whereas the second housing part is a circular disc,
the first and the second housing part are electrically isolated from one another by an annular seal having electrically insulating properties, and
the first housing part is electrically connected to the positive electrode and the second housing part is electrically connected to the negative electrode.

6. The battery according to claim 1, wherein
the housing comprises the metal housing part as a first housing part and a further metal housing part as second housing part,
the first housing part has a cup-shaped design and a circular base and an annular side wall, whereas the second housing part is a circular disc,
the first and the second housing part are electrically isolated from one another by an annular seal having electrically insulating properties, and
the first housing part is electrically connected to the negative electrode and the second housing part is electrically connected to the positive electrode.

7. The battery according to claim 1, wherein
the housing comprises the metal housing part as first housing part and a further non-metal housing part as second housing part,
the metal housing part is designed as a prismatic container that has a polygonal base with n sides and n rectangular side walls that enclose a right angle with the base, wherein n is an integer from 4 to 8, and
the second housing part serves as cover for the first housing part and closes off an opening defined by the n rectangular side walls.

8. The battery according to claim 1, wherein:
the housing comprises the metal housing part as first housing part and a further metal housing part as second housing part,
the metal housing part is a prismatic container having a polygonal base with n sides and n rectangular side walls that enclose a right angle with the base, wherein n is an integer from 4 to 8, and
the second housing part serves as cover for the first housing part and closes off an opening defined by the n rectangular side walls.

9. The battery according to claim 1, wherein at least one of:
the first layer comprises lithium in addition to the aluminium or the aluminium alloy,
the first layer is coated with a layer consisting of lithium,
the first layer is lithium-doped, and
the aluminium in the first layer is alloyed with lithium.

10. A method of manufacturing the battery according to claim 1, comprising:
providing a foil or a metal sheet consisting of aluminium or of an aluminium alloy,
applying a layer consisting of nickel or of a nickel alloy to one side of the foil or of the metal sheet,
shaping the foil or metal sheet resulting from step (b) using a deep-drawing tool to form a metal housing part the inner side of which is formed by the foil or the metal sheet consisting of the aluminium or of the aluminium alloy and the outer side of which is formed by the layer consisting of the nickel or of the nickel alloy, and
assembling the lithium battery using the housing part formed in step (c).

11. The method according to claim 10, further comprising:
applying the layer consisting of the nickel or of the nickel alloy to the foil or the metal sheet consisting of the aluminium or the aluminium alloy through a CVD or a PVD method.

12. The method according to claim 10, further comprising:
roll-coating a foil consisting of nickel or of the nickel alloy onto the foil or onto the metal sheet consisting of the aluminium or the aluminium alloy to form the layer consisting of the nickel or of the nickel alloy.
